(19) United States
(12) Patent Application Publication
(10) Pub. No.: US 2024/0201366 A1
(43) Pub. Date: Jun. 20, 2024

(54) MILLIMETER-WAVE-TRANSMITTING GARNISH

(71) Applicant: TOYODA GOSEI CO., LTD., Kiyosu-shi, Aichi-ken (JP)

(72) Inventors: Kozo HIROTANI, Kiyosu-shi, Aichi-ken (JP); Kazuyoshi FUJIMOTO, Kiyosu-shi, Aichi-ken (JP); Yosuke MARUOKA, Kiyosu-shi, Aichi-ken (JP); Yutaka OTSUKA, Kiyosu-shi, Aichi-ken (JP)

(21) Appl. No.: 18/556,806

(22) PCT Filed: May 18, 2022
(86) PCT No.: PCT/JP2022/020739

§ 371 Date: Oct. 23, 2023

(30) Foreign Application Priority Data
May 31, 2021 (JP) 2021-090929

(51) Int. Cl. G01S 13/931; H01Q 1/32

(52) U.S. Cl. CPC G01S 13/931; H01Q 1/3233

(57) ABSTRACT

A millimeter wave transmissive decoration is arranged forward of a millimeter wave radar device in an emission direction of millimeter waves. The millimeter wave transmissive decoration includes a layer structure including layers stacked in the emission direction. The layers include a decorative layer and a plastic layer. At least part of the decorative layer is made of a white plastic layer. The plastic layer is in contact with the white plastic layer. The white plastic layer is made of a polycarbonate plastic containing particles of titanium oxide having a rutile crystal structure. A thickness in the emission direction of the white plastic layer is less than or equal to 2.0 mm. A permittivity of the white plastic layer is less than or equal to 3.1. An L value in a Lab color space of the white plastic layer is greater than or equal to 80.

### TECHNICAL FIELD

The present disclosure relates to a millimeter wave transmissive decoration employed in a vehicle equipped with a millimeter wave radar device that emits and receives millimeter waves. The millimeter wave transmissive decoration permits passage of millimeter waves and decorates the vehicle.

### BACKGROUND ART

A millimeter wave radar device mounted on a land vehicle emits millimeter waves to the outside of the land vehicle. The millimeter waves that hit, and are reflected by, an object outside the land vehicle, such as a leading land vehicle or a pedestrian, are received by the millimeter wave radar device. Based on the emitted and received millimeter waves, the millimeter wave radar device recognizes the object and detects the distance and the relative velocity between the land vehicle and the object.

The above-described land vehicle includes a millimeter wave transmissive decoration located forward of the millimeter wave radar device in a millimeter wave emission direction. The millimeter wave transmissive decoration is, for example, a front grille or an emblem. The millimeter wave transmissive decoration includes a layer structure including layers stacked in the emission direction. One of the layers is a decorative layer. The decorative layer, for example, has a metallic luster at least in a part. Thus, when the millimeter wave transmissive decoration is viewed from the outside of the land vehicle, at least part of the decorative layer looks lustrous like metal. The decorative layer decorates the millimeter wave transmissive decoration, improving the appearance of the millimeter wave transmissive decoration and the surrounding portion in the land vehicle.

In recent years, there have been demands to cause the metallic luster to appear white in a decorative layer while ensuring the transmissivity for millimeter waves.

In this regard, for example, Patent Literature 1 discloses a pigment 7 of Comparative Examples 2 and 3, which is a white pigment made by coating glass flakes (base material) with rutile-type titanium dioxide. The pigment 7 is contained in a lustrous coating forming a decorative layer.

Patent Literature 2 discloses a lustrous pigment, in which a titanium oxide layer made of rutile-type titanium oxide and a silver layer are laminated in that order on glass flakes. Using a composition containing this lustrous pigment to form the above-mentioned decorative layer causes the decorative layer to appear white.

### CITATION LIST

### Patent Documents

Patent Document 1: Japanese Laid-Open Patent Publication No. 2009-102626.
Patent Document 2: Japanese Patent No. 6227850

### SUMMARY OF INVENTION

### Technical Problem

The techniques described in Patent Literature 1 and Patent Literature 2 are used to cause metallic luster of a decorative layer to appear white. Thus, these techniques are not suitable for millimeter wave transmissive decorations, in which at least part of a decorative layer is formed by a white plastic layer, when the white plastic layer is desired to appear white.

Such a problem can also occur in a case in which a millimeter wave transmissive decoration is attached to a vehicle other than a land vehicle.

### Solution to Problem

To achieve the forgoing objectives, a millimeter wave transmissive decoration is employed in a vehicle equipped with a millimeter wave radar device that emits and receives millimeter waves. The millimeter wave transmissive decoration is configured to be arranged forward of the millimeter wave radar device in an emission direction of the millimeter waves. The millimeter wave transmissive decoration includes a layer structure that includes layers stacked in the emission direction. The layers include a decorative layer configured to decorate the vehicle and a plastic layer. At least part of the decorative layer is made of a white plastic layer. The plastic layer is in contact with the white plastic layer. The white plastic layer is made of a polycarbonate plastic containing particles of titanium oxide having a rutile crystal structure. A thickness in the emission direction of the white plastic layer is less than or equal to 2.0 mm. A permittivity of the white plastic layer is less than or equal to 3.1. An L value in a Lab color space of the white plastic layer is greater than or equal to 80.

### BRIEF DESCRIPTION OF DRAWINGS

FIG. 1 is a partial cross-sectional plan view showing a millimeter wave transmissive decoration, which is a land vehicle emblem according to an embodiment, illustrating a layer structure of the emblem together with a millimeter wave radar device.

FIG. 2 is a diagram showing a relationship of an additive rate of titanium oxide in a white plastic layer to a permittivity and an L value of the white plastic layer.

### DESCRIPTION OF EMBODIMENTS

A millimeter wave transmissive decoration according to an embodiment will now be described with reference to the drawings. In the embodiment, the millimeter wave transmissive decoration is a land vehicle emblem.

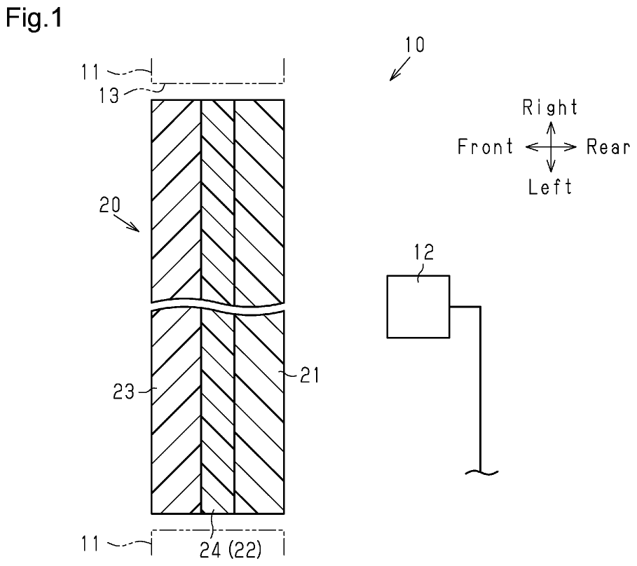

In the following description, the direction in which the vehicle advances forward will be referred to as the front, and the reverse direction will be referred to as the rear. Also, the left-right direction refers to the vehicle width direction that agrees with the left-right direction when the vehicle is advancing forward. In FIG. 1, in order to make the size of each component recognizable, the scale of each component is altered as necessary.

As shown in FIG. 1, a land vehicle 10 is equipped with a front monitoring millimeter wave radar device 12 arranged at the front. The millimeter wave radar device 12 is located at the center in the left-right direction and behind a front grille 11. In FIG. 1, the front grille 11 is shown by the long-dash double-short-dash lines. The millimeter wave radar device 12 has a sensor function of emitting millimeter waves, which are electromagnetic waves, toward a predetermined angular range in front of the land vehicle 10 and receiving millimeter waves that have struck and have been reflected by an object outside the land vehicle 10 including a leading land vehicle, pedestrians, and the like. Millimeter waves are radio waves with wavelengths in a range of 1 mm to 10 mm and frequencies in a range of 30 GHz to 300 GHz. The millimeter wave radar device 12 is characterized by being resistant to bad weather such as rain, fog, and snow, and having a longer detectable distance than other methods.

As described above, the millimeter wave radar device 12 emits millimeter waves forward from the land vehicle 10. Thus, the emission direction of the millimeter waves from the millimeter wave radar device 12 is the direction from the rear toward the front of the land vehicle 10. The front in the emission direction of the millimeter waves substantially agrees with the front of the land vehicle 10. The rear in the emission direction also substantially agrees with the rear of the land vehicle 10. Accordingly, in the following description, the front in the emission direction of millimeter waves will simply be referred to as “forward” or “front.” The rear in the emission direction will simply be referred to as “rearward” or “rear.”

Like a typical front grille, the thickness (the dimension in the front-rear direction) of the front grille 11 is uneven. The front grille 11 may include a plastic base with plating on the surface. In this case, the front grille 11 interferes with the emitted or reflected millimeter waves. As such, the front grille 11 includes a window 13 at a portion millimeter waves of the millimeter wave radar device 12 pass, specifically, at a portion of the front grille 11 that is located in front of the millimeter wave radar device 12.

An emblem 20 is disposed in the window 13. The emblem 20 is arranged upright such that its front surface faces the front of the land vehicle 10 and its rear surface faces the rear of the land vehicle 10.

The emblem 20 has a layer structure including layers stacked in the front-rear direction. The layers include a base 21, a decorative layer 22, and a transparent plastic layer 23, which are arranged in that order from the rear toward the front. Among these layers, the base 21 and the transparent plastic layer 23 correspond to the plastic layer of the claims.

### Base 21

The base 21, which is part of the plastic layer, is made of a plastic material that is transmissive to millimeter waves. In the present embodiment, the base 21 is made of a colored plastic of acrylonitrile-ethylene-styrene (AES) copolymer. The color of the base 21 is, for example, blue or black. The permittivity of AES is approximately 2.7, and the dielectric dissipation factor is 0.007.

The permittivity is a physical property value that indicates the degree of the properties in which a dielectric polarization is caused in response to the electric charge of a dielectric, which is the base 21 in this case. The permittivity is the ratio of the electric flux density to the electric field strength. In general, the higher the permittivity, the more likely electric charge accumulates. The dielectric dissipation factor is an index value that indicates the degree of electrical energy loss in a dielectric, that is, the amount by which a signal propagating through a dielectric is converted into heat and lost. When the dielectric dissipation factor is low, it is difficult for millimeter waves to be converted into thermal energy, making it possible to suppress the attenuation of millimeter waves.

Instead of the AES plastic, the base 21 may be made of a plastic that has a relative permittivity close to that of the transparent plastic layer 23, such as acrylonitrile-styrene-acrylate copolymer (ASA) plastic or polycarbonate (PC) plastic. The relative permittivity refers to the ratio of the permittivity of a dielectric, which is the base 21 in this case, to the permittivity of vacuum. The relative permittivity is a parameter indicating the degree of polarization within the dielectric. The higher the relative permittivity, the greater the propagation delay of millimeter waves becomes. Thus, it is preferred that the relative permittivity be low in order to increase the propagation speed of millimeter waves and allow for high-speed calculation of the millimeter wave radar device 12.

Further, the base 21 may be made of a polymer alloy of PC plastic and acrylonitrile-butadiene-styrene (ABS) plastic.

### Transparent Plastic Layer 23

The transparent plastic layer 23, which is part of the plastic layer, is made of a plastic material that is transmissive to millimeter waves. The transparent plastic layer 23 is disposed in front of the base 21. The transparent plastic layer 23 is made of a transparent PC plastic, which has a relatively low dielectric dissipation factor. The permittivity of PC plastic is 2.7, the dielectric dissipation factor is 0.006, and the relative permittivity is substantially the same as the relative permittivity of AES plastic. The transparent plastic layer 23 may be made of polymethyl methacrylate (PMMA) plastic, which has a relatively low dielectric dissipation factor like the above-described PC plastic.

### Decorative Layer 22

The decorative layer 22 decorates the emblem 20 and the surrounding portion of the emblem 20 in the front part of the land vehicle 10. The decorative layer 22 is arranged between the base 21 and the transparent plastic layer 23.

At least part of the decorative layer 22 is made of a white plastic layer 24. In the present embodiment, the white plastic layer 24 is used to express patterns such as letters and marks. Such patterns are generally expressed by a lustrous decorative layer made of a metal material. In the present embodiment, from the viewpoint of design of the emblem 20, the patterns are expressed by the white plastic layer 24 instead of the lustrous decorative layer. The rear surface of the white plastic layer 24 is in contact with the front surface of the base 21, and the front surface of the white plastic layer 24 is in contact with the rear surface of the transparent plastic layer 23.

The white plastic layer 24 is formed by mixing particles of titanium oxide (TiO₂) as a white pigment with PC plastic, which is transmissive to millimeter wave. That is, the white plastic layer 24 is formed from PC plastic containing particles of titanium oxide.

Titanium oxide has the highest refractive index among inorganic pigments. Titanium oxide has excellent coating power and hiding power, and is chemically stable. The hiding power is an ability of a pigment to hide the surface to which the pigment is applied by reflection, scattering, or absorption of light. In the case of a white pigment, the hiding power is exhibited by reflection and scattering of light. As such, titanium oxide is used mainly for the white pigment. Since titanium oxide does not absorb light in the visible light range, it appears whiter.

The titanium oxide has three types of crystal structures, namely, anatase (tetragonal), brookite (orthorhombic), and rutile (tetragonal). Among these, anatase and rutile are industrially manufactured. Rutile-type titanium oxide is suitable for being mixed as a pigment in a coating composition and a plastic composition. Further, rutile-type titanium oxide has an atomic arrangement that is more closely packed by anatase-type titanium oxide, and thus has a relatively high refractive index.

When anatase-type titanium oxide is heated to 900° C. or higher, transition to rutile-type titanium oxide occurs. When brookite-type titanium oxide is heated to 650° C. or higher, transition to rutile-type titanium oxide occurs. Once transition to rutile type occurs, titanium oxide maintains the rutile type even when it is returned to a low temperature. Thus, rutile-type titanium oxide is most stable among the three types of crystal structures.

The permittivity and the dielectric dissipation factor of rutile-type titanium oxide and anatase-type titanium oxide were measured, and it was found that the permittivity and the dielectric dissipation factor of the rutile type were smaller than those of the anatase type.

In the present embodiment, the white plastic layer 24 is made of a PC plastic containing particles of rutile-type titanium oxide.

The white plastic layer 24 meets the following conditions.
(A) The thickness, in this case, the dimension in the front-rear direction is less than or equal to 2.0 mm.
(B) When the millimeter wave radar device 12 emits millimeter waves in a band that has a median frequency of 76.5 GHZ, the permittivity is less than or equal to 3.1. This value is close to the permittivity (2.7) of PC plastic and to the permittivity (approximately 2.7) of AES plastic.
(C) The L value in the Lab color space is greater than or equal to 80.

The Lab color space is one of the methods for expressing colors of objects by numeric values. The L value in the Lab color space represents brightness. The lower the L value, the lower the brightness becomes. The greater the L value, the higher the brightness becomes.

The lower limit value of the thickness of the white plastic layer 24 is preferably 1.0 mm in order to allow the white plastic layer 24 to be stably molded with plastic.

Factors related to both the permittivity and the L value of the white plastic layer 24 include the additive rate of titanium oxide to the white plastic layer 24. The additive rate is the ratio of titanium oxide when the volume of the entire white plastic layer 24, which is composed of PC plastic and titanium oxide, is 100.

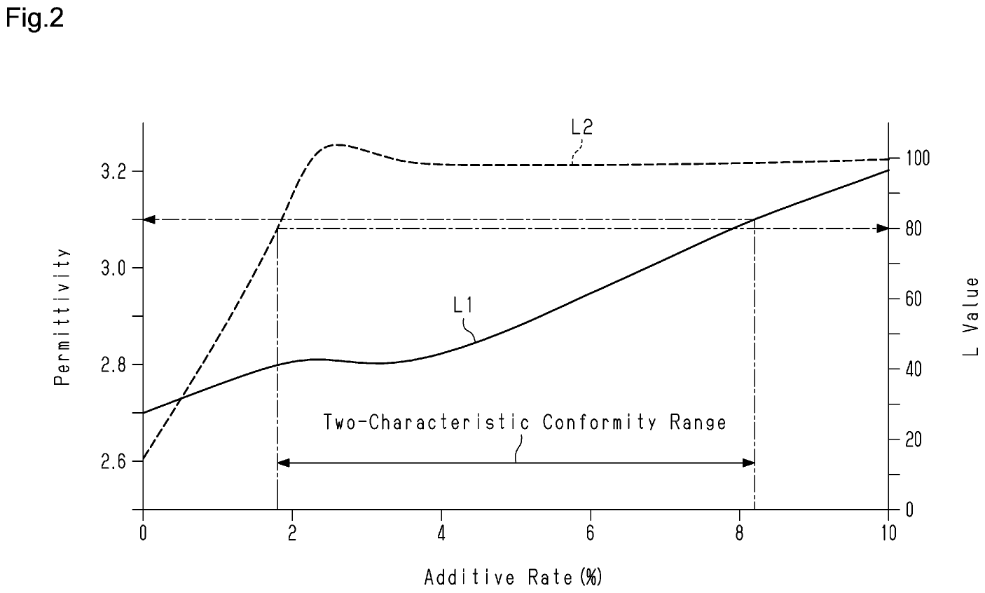

FIG. 2 shows the results of measurement of changes in the permittivity and the L value when the additive rate was changed in a range of 0% to 10%. In FIG. 2, the permittivity is indicated by a characteristic line L1 and the L value is indicated by a characteristic line L2.

When the additive rate was 0%, that is, when titanium oxide was not added and the white plastic layer 24 was made of only PC plastic, the permittivity was 2.7, and the L value was approximately 15. In contrast, when the additive rate was 10%, the permittivity was approximately 3.2, and the L value was approximately 100.

When the additive rate changed in a range of 0% to 2%, the permittivity increased as the additive rate increased. When the additive rate changed in a range of 2% to 4%, the permittivity was substantially constant at approximately 2.8. When the additive rate changed in a range of 4% to 10%, the permittivity increased as the additive rate increased.

Also, when the additive rate changed in the range of 0% to 2%, the L value increased as the additive rate increased. When the additive rate changed in the range of 2% to 4%, the L value temporarily increased as the additive rate increased, and then decreased to approximately 100. When the additive rate changed in the range of 4% to 10%, the L value was substantially constant at approximately 100.

FIG. 2 reveals the following.

When the additive rate is in a range of 0% to 8.2%, the permittivity is less than or equal to 3.1, and the condition (B) is met.

When the additive rate is in a range of 1.8% to 10%, the L value is greater than or equal to 80, and the condition (C) is met.

The range in which the above-described range of 0% to 8.2% overlaps with the above-described range of 1.8% to 10% will be referred to as a two-characteristic conformity range. In this two-characteristic conformity range, the permittivity is less than or equal to 3.1, and the L value is greater than or equal to 80.

In the present embodiment, the additive rate is set to 1.8% to 8.2%, so that the conditions (B) and (C) are both met.

When the white plastic layer 24 forms part of the decorative layer 22, a portion of the decorative layer 22 that is different from the white plastic layer 24 may be a colored decorative layer having a color other than white, for example, black or blue. Further, the above-described part may be made of a lustrous decorative layer made of a metal material such as indium (In).

Operation of the above-described present embodiment will now be described.

Advantages that accompany the operation will also be described.

### Millimeter Wave Transmissivity of White Plastic Layer 24

In FIG. 1, when millimeter waves are emitted from the millimeter wave radar device 12, the millimeter waves pass through the layers of the emblem 20 (i.e., the base 21, the decorative layer 22, and the transparent plastic layer 23) in that order. After passing through the emblem 20, the millimeter waves strike and are reflected by an object in front of the land vehicle 10 including, for example, a leading vehicle and a pedestrian. Then, the millimeter waves again pass through the layers of the emblem 20 in reverse order and are received by the millimeter wave radar device 12. Based on the emitted and received millimeter waves, the millimeter wave radar device 12 recognizes the object and detects, for example, the distance between the land vehicle 10 and the object and the relative velocity.

(1-1) As described above with reference to FIG. 2, a certain relationship exists between the additive rate of titanium oxide to the white plastic layer 24 and the permittivity of the white plastic layer 24. When the additive rate is less than or equal to 8.2%, the permittivity is less than or equal to 3.1. In this regard, the additive rate is set to 1.8% to 8.2% in the present embodiment. Thus, the permittivity of the white plastic layer 24 is less than or equal to 3.1, which provides necessary millimeter wave transmissivity.

As shown in FIG. 1, the base 21 is in contact with the rear surface of the white plastic layer 24. The permittivity of the AES plastic used to form the base 21 is approximately 2.7. In contrast, the permittivity of the white plastic layer 24 is less than or equal to 3.1 as described above, and is close to the permittivity of the base 21. Thus, when millimeter waves pass through the base 21 and the white plastic layer 24, the millimeter waves are prevented from being reflected or refracted by the interface between the base 21 and the white plastic layer 24. This limits attenuation of the millimeter waves due to reflection and refraction.

Further, the transparent plastic layer 23 is in contact with the front surface of the white plastic layer 24. The PC plastic used to form the transparent plastic layer 23 has a permittivity of 2.7. As described above, the permittivity of the white plastic layer 24 is less than or equal to 3.1 and is close to the permittivity of the transparent plastic layer 23. Thus, when millimeter waves pass through the white plastic layer 24 and the transparent plastic layer 23, the millimeter waves are prevented from being reflected or refracted by the interface between the white plastic layer 24 and the transparent plastic layer 23. This limits attenuation of the millimeter waves due to reflection and refraction.

(1-2) Further, in the present embodiment, the titanium oxide has a rutile crystal structure. As described above, the permittivity and the dielectric dissipation factor of rutile-type titanium oxide are lower than those of anatase-type titanium oxide. Thus, as compared with a case in which titanium oxide having an anatase crystal structure is used, attenuation of millimeter waves is suppressed, so that the millimeter wave transmissivity is ensured.

(1-3) The millimeter waves emitted from the millimeter wave radar device 12, as well as the millimeter waves that strike and are reflected by an object outside the land vehicle 10, are attenuated to some extent when passing through the white plastic layer 24. A relationship is observed between the attenuation amount of millimeter waves and the thickness of the white plastic layer 24, where the attenuation increases as the thickness becomes larger. In the present embodiment, the thickness of the white plastic layer 24 is set to be less than or equal to 2.0 mm. Thus, the amount of attenuation of millimeter waves is limited to an allowable range.

As described in items (1-1) to (1-3) above, the present embodiment limits attenuation of millimeter waves when passing through the emblem 20 and limits reduction in the detection performance of the millimeter wave radar device 12 caused by attenuation of millimeter waves.

### White Appearance of White Plastic Layer 24

When the emblem 20 is irradiated with visible light from ahead of the land vehicle 10 as shown in FIG. 1, the visible light passes through the transparent plastic layer 23 and is applied to particles of titanium oxide in the white plastic layer 24. The visible light is not absorbed or is unlikely to be absorbed by the above-described particles, and most of the light is diffusely reflected. Thus, when the emblem 20 is seen from ahead of the land vehicle 10, the white plastic layer 24 appears to be located behind (farther than) the transparent plastic layer 23 through the transparent plastic layer 23.

(2-1) As described above with reference to FIG. 2, a certain relationship exists between the additive rate of titanium oxide to the white plastic layer 24 and the L value. When the additive rate is greater than or equal to 1.8%, the L value is greater than or equal to 80. In this regard, the additive rate is set to 1.8% to 8.2% in the present embodiment. Thus, the L value of the white plastic layer 24 is greater than or equal to 80, which causes the white plastic layer 24 to appear white. The white plastic layer 24 appears white through the transparent plastic layer 23. As described above, the white plastic layer 24 is used to express patterns such as letters and marks in the present embodiment. The white plastic layer 24 allows the patterns to appear white.

In the present embodiment, the emblem 20 is decorated with the white plastic layer 24 to improve the appearance of the emblem 20 and the surrounding portion in the front part of the land vehicle 10.

In addition to the ones listed above, the present embodiment has the following advantages.

(3-1) The reflection of visible light on the white plastic layer 24 occurs at a position forward of the millimeter wave radar device 12. Further, the base 21 is located behind the white plastic layer 24. The color of the base 21 is a dark color such as blue or black. The white plastic layer 24 and the base 21 have a function of concealing the millimeter wave radar device 12. Accordingly, the millimeter wave radar device 12 cannot be seen easily from the front of the emblem 20. The appearance of the front part of the land vehicle 10 is thus improved as compared with a case in which the millimeter wave radar device 12 is visible through the emblem 20.

The above-described embodiment may be modified as follows. The above-described embodiment and the following modifications can be combined if the combined modifications remain technically consistent with each other.

### Modifications to White Plastic Layer 24

The decorative layer 22 may be modified as long as at least part of the decorative layer 22 is made of the white plastic layer 24. Thus, the entire decorative layer 22 may be formed by the white plastic layer 24. Further, the decorative layer 22 may be formed by a combination of the white plastic layer 24 and at least one of the above-described colored decorative layer and lustrous decorative layer.

### Modification to Layer Structure of Emblem 20

The emblem 20 has a layer structure including layers stacked in the front-rear direction. The layers include the decorative layer 22. The structure of layers other than the decorative layer 22 in this layer structure may differ from that of the above-described embodiment. For example, the structure may be modified as follows.

The number of the layers in the layer structure may be changed to two or more than three.

At least one of the transparent plastic layer 23 and the base 21 in the above-described embodiment may be omitted.

If a layer is provided forward of the decorative layer 22, that layer is made of a colorless transparent plastic material so that the white plastic layer 24 is visible through the layer from the outside of the land vehicle 10.

If a layer is provided behind the decorative layer 22, that layer may be either transparent or opaque.

### Other Modifications

The millimeter wave transmissive decoration may be used for a decorative part different from the emblem 20 as long as the millimeter wave transmissive decoration is located forward of the millimeter wave radar device 12 in the millimeter wave emission direction, is used to decorate the land vehicle 10, and has transmissivity for millimeter waves.

The millimeter wave radar device 12 is not limited to a front monitoring device, but may be a device that monitors the situation behind the vehicle, the situation on the sides of the front part of the vehicle, or the situation on the sides of the rear part of the vehicle. In this case, a millimeter wave transmissive decoration is arranged forward of the millimeter wave radar device 12 in an emission direction of millimeter waves.

The millimeter wave transmissive decoration may be used in a case in which the millimeter wave radar device 12 is mounted on a vehicle of a type different from a land vehicle, for example, an electric train, an aircraft, or a ship.

1. A millimeter wave transmissive decoration employed in a vehicle equipped with a millimeter wave radar device that emits and receives millimeter waves, the millimeter wave transmissive decoration being configured to be arranged forward of the millimeter wave radar device in an emission direction of the millimeter waves, the millimeter wave transmissive decoration comprising a layer structure that includes layers stacked in the emission direction, wherein
the layers include a decorative layer configured to decorate the vehicle and a plastic layer,
at least part of the decorative layer is made of a white plastic layer,
the plastic layer is in contact with the white plastic layer,
the white plastic layer is made of a polycarbonate plastic containing particles of titanium oxide having a rutile crystal structure,
a thickness in the emission direction of the white plastic layer is less than or equal to 2.0 mm,
a permittivity of the white plastic layer is less than or equal to 3.1, and
an L value in a Lab color space of the white plastic layer is greater than or equal to 80.

2. The millimeter wave transmissive decoration according to claim 1, wherein the titanium oxide is added to the white plastic layer at an additive rate in a range of 1.8% to 8.2%.

3. The millimeter wave transmissive decoration according to claim 1, wherein
the plastic layer includes a transparent plastic layer made of a polycarbonate plastic, and
the transparent plastic layer is in contact with a front surface of the white plastic layer in the emission direction.

4. The millimeter wave transmissive decoration according to claim 1, wherein
the plastic layer includes a base made of acrylonitrile-ethylene-styrene copolymer plastic, and
the base is in contact with a rear surface of the white plastic layer in the emission direction.
